(19) United States
(12) Patent Application Publication
(10) Pub. No.: US 2006/0018126 A1
(43) Pub. Date: Jan. 26, 2006

(54) Edge-lit lighted panel for bulletin boards

(76) Inventors: Kueun Choi, Trumbull, CT (US); Kue Dong Choi, Middletown, CT (US); Kue Byung Choi, Trumbull, CT (US)

Correspondence Address: Dr. Kueun Choi, 5 Camelot Dr., P. O. Box 591, Trumbull, CT, 06611, US

(21) Appl. No.: 10/896,708

(22) Filed: Jul. 22, 2004

(51) Int. Cl. F21V 8/00

(52) U.S. Cl. 362/600

(57) ABSTRACT

An edge-lit lighted panel for bulletin boards comprising a generally planar rectangular panel of light-transmitting material having a top surface and bottom surface surrounded by four edge surfaces, and at least one linear light source imbedded in and sealed along at least one edge surface. The linear light source includes a longitudinal semi-circular reflector to direct the light from the linear light source toward the adjacent edge surface to increase the amount of light entering the edge surface of the planar rectangular light-transmitting panel. The linear light source and the longitudinal semi-circular reflector are installed inside an edge trim housing that is configured to be attached to the edge surface of the planar rectangular light-transmitting panel. In order to maximize illumination, the remaining three edge surfaces of the planar rectangular light-transmitting panel are covered with light-reflecting tapes to ensure maximum reflection of the light therein and are protected by stainless steel trim frames. Opaque pigment markers are required to achieve the best illuminated results of messages written on the edge-lit lighted panels. The repeated reflection and refraction of the rays of light within the light-transmitting panel illuminate the traces of the opaque pigment markers, and make such traces appear bright and glowing to the eyes of observers.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

The present invention generally pertains to edge-lit lighting devices and, more specifically, to edge-lit lighted panels that illuminate messages written thereon with opaque pigment markers.

2. Background of the Invention

Various types of bulletin boards are used to convey messages and information to customers in stores, restaurants and the like to call attention to items on sale or daily specials on the menu. Typically, such announcements are written on small blackboards, clipboards or sheets of paper because they are normally transient in nature and tend to be in effect for relatively short periods of time before new messages replace them.

Exit signs, open signs and the like are among the most popular electrically illuminated display signs but are not designed to be changed. Most popular illuminated display signs available today incorporate inalterable etchings and engravings. While such electrical lighting devices are widely utilized to display visually appealing signs, their functional features are incompatible with the requirements of bulletin boards whereon messages are written and erased as frequently as routine business practices require.

The patent search process for the present invention focused on applications of edge-lit illumination systems for bulletin boards on which messages can be written and erased as often as needed. While it was determined that numerous patents have been issued in the field of liquid crystal panel illumination systems for computers, a relatively short list of patents have been identified for lighting systems for large scale signs or graphic displays. However, no patent has been located in the field of lighting systems for bulletin boards that illuminate messages written with opaque pigment markers.

Currently, small blackboards, clipboards, or sheets of paper are used to display temporary messages. There is a definite need for improved and efficient bulletin boards to replace the current method of displaying messages and information. Therefore, the object of the present invention is to create edge-lit lighted panels for bulletin boards whereon messages can be written with opaque pigment markers that are attractive and draw the attention of desired viewers. For this purpose, the patent search for the present invention focused on prior art edge-lit lighting devices. To be relevant to the present invention, they must be free of any permanent signs or letters incorporated into each product by way of etching or engraving on lighted display surfaces. The following are such prior art devices that meet the basic requirements:

U.S. Pat. No. 6,450,657 issued to Testa et al. sets forth a LIGHTED PANEL DEVICE ABLE TO BE APPLIED ONTO POSTS, comprises at least a board with a frame having, as its horizontal sides, lower and upper elongated plates and, as its vertical sides, two uprights and luminous display panel, housed in said frame. If the panel is a clear sheet bearing images and/or captions, two fluorescent lamps, housed within each upright, emit light only within the sheet through longitudinal openings of the uprights.

U.S. Pat. No. 5,499,165 issued to Holmes sets forth a TRANSPARENT EDGE-LIT LIGHTING PANE FOR DISPLAYS that includes a generally rectangular panel of transparent material tapering from one edge to the opposite edge to form a wedge shape and a linear light source is imbedded in and sealed thereto along the thicker edge of the rectangular panel. This edge-lit lighting pane is designed to illuminate maps, pictures and photographs that are placed thereon in environments having a low ambient light level.

U.S. Pat. No. 5,375,043 issued to Tokunaga sets forth a LIGHTING UNIT, capable of varying the luminance and color of illumination with respect to a target to be lit thereby ensuring an effective display of the target and further capable of using itself as a display unit. The lighting unit comprises a light guide plate having one side fashioned into an uneven surface or a reflective surface; a plurality of light emitting diodes for supplying a light to the light guide plate, the light derived from the diodes being dispersed through the light guide plate; and a control section which controls actions including blinking of the light emitting diodes.

U.S. Pat. No. 5,276,591 issued to Hegarty sets forth a SIGN WITH INDIRECT ILLUMINATION FROM LIGHT EMITTING DIODES using high brightness LEDs and a translucent graphic panel with suitable opacity for the transmission of light. The graphic panel is illuminated by light from the LEDs which is injected into the edge of the graphic panel causing graphics applied to a surface of the graphic panel to become illuminated. Light injected into the edge of the graphic panel is efficiently diffused without the uses of a diffusing sheet between the LEDs and the graphic panel. Unlike illuminated signs that use LEDs for direct illumination of a graphic panel, the invention produces an equivalent level of graphic brightness while requiring fewer LEDs.

U.S. Pat. No. 5,027,258 issued to Schoniger sets forth a DISPLAY UNIT which is designed to illuminate a display unit such as a board with a house number thereon or an advertising billboard. The light guide panel serves for illuminating logo symbols, which are preferably in the form of film or of vapor coated layers, on the light guide panel.

U.S. Pat. No. 4,870,484 issued to Sonehara sets forth a COLOR DISPLAY DEVICE USING LIGHT SHUTTER AND COLOR FILTERS providing a bright picture with high saturation and excellent color reproduction. The color display device includes a light shutter mechanism which controls the amount of light passing therethrough. Color filters of different colors are disposed adjacent to the light shutter mechanism and include a plurality of color elements.

U.S. Pat. No. 4,751,615 issued to Abrams sets forth a PAGE LIGHT for a personal reading and writing light or illumination device having a tapered transparent body with an opening at one end for receiving an illumination source and with a discontinuity adjacent to the opening to improve uniformity of illumination of the body and of a reading or writing work surface in contact with the body. The ends and sides of the body are configured or otherwise treated to maximize reflection and minimize illumination of adjacent areas.

While the foregoing prior art devices each have in common the capacity to project light into an edge surface of a light-transmitting panel to illuminate the target objects or areas such as maps, pictures, and advertising billboards, their lighting surfaces are free of any permanent light reflecting etchings or engravings thereon. None of the prior art devices cited above were designed to illuminate temporary messages written on the lighting surface with opaque pigment markers.

It is, therefore, the primary object of this invention to provide an edge-lit lighted panel for bulletin boards whereon messages can readily be written with opaque pigment markers, and can also be erased just as easily.

It is also an object of this invention to provide an edge-lit lighted panel that is portable and of sizes equivalent to currently popular bulletin boards that are used to display messages and information in stores, restaurants and the like.

### SUMMARY OF THE INVENTION

The present invention is to provide a lighted panel for bulletin boards to replace black boards, clip boards or sheets of paper that are currently used as a popular means of communicating to customers in stores and restaurants. Since these announcements are normally hung or pasted on limited wall spaces indoors, the edge-lit lighted panels for bulletin boards provide ideal replacements for the current means of communicating to customers by effectively satisfying minimum space requirements.

In accordance with the present invention, there is provided an edge-lit lighted panel for bulletin boards comprising a generally planar rectangular panel of light-transmitting material having a top surface and bottom surface surrounded by four edge surfaces, and at least one linear light source imbedded in and sealed thereto along at least one edge surface. The linear light source includes a longitudinal semi-circular reflector to direct the light from the linear light source toward the adjacent edge surface to increase the amount of light entering the edge surface of the planar rectangular panel. The linear light source and the longitudinal semi-circular reflector are installed inside an edge trim housing that is configured to be attached to the edge surface of the planar rectangular light-transmitting panel. In order to maximize illumination, the remaining three edge surfaces of the planar rectangular light-transmitting panel are covered with light-tape to insure maximum reflection of the light therein and are protected by stainless steel trim frames.

The edge-lit lighted panel for bulletin boards can be hung on a wall space either in a vertical or in a horizontal format adapted to the nature of messages and information to be displayed. Opaque pigment markers are required to achieve the best illuminated results of messages written on the edge-lit lighted panels. The repeated reflection and refraction of the rays of light within the light-transmitting panel illuminates the traces of the opaque pigment markers, and make such traces appear bright and glowing to the eyes of observers.

### BRIEF DESCRIPTION OF THE DRAWINGS

The aforementioned objects and advantages of the present invention will be appreciated from the following description and accompanying drawings wherein:

FIG. 1 shows a perspective view of a planar rectangular edge-lit lighted panel for bulletin boards,

FIG. 2 shows a linear light source (i.e., cold cathode florescent lamp (CCFL)), a longitudinal semi-circular reflector, an inverter and a trim housing for the linear light source,

FIG. 3 shows a planar rectangular light-transmitting panel and light reflecting tape for edge surfaces, and trim frames,

FIG. 4 shows a planar rectangular light-transmitting panel, a light reflection panel and a protective back panel, and

FIG. 5 displays a cross-sectional view of a light-transmitting panel showing light reflecting pattern against the top and bottom surfaces of the panel and also against the traces of opaque pigment markers.

### DRAWINGS ? REFERENCE NUMERALS

1 Planar rectangular light-transmitting panel
2 Trim housing for a linear light source
3 Stainless steel edge trim frames
4 Linear light source (CCFL)
5 Longitudinal semicircular light reflector
6 Light reflecting tapes for edge surfaces
7 Light reflection panel
8 Protective back panel
9 Inverter
10 Tubular pins for the trim housing for a linear light source
11 Screws for edge trim frames
12 Hooks for installation
13 Top surface of the light-transmitting panel
14 Bottom surface of the light-transmitting panel
15 Traces of opaque pigment markers
16 Holes on the light-transmitting panel for tubular pins
17 Holes on the trim housing for tubular pins
18 Top edge surface of the light-transmitting panel
19 Left edge surface
20 Right edge surface
21 Bottom edge surface
22 Rays of light

### DESCRIPTION OF THE PREFERRED EMBODIMENTS

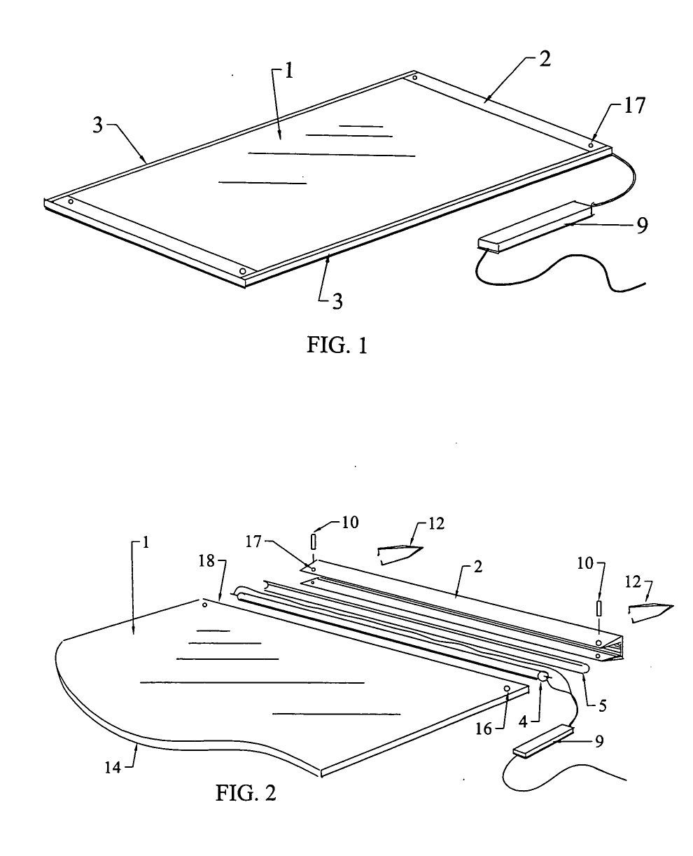

Referring to FIG. 1, this shows an edge-lit lighted panel for bulletin boards in a perspective view. In this view, a light-transmitting panel 1 in a planar rectangular shape is enclosed with a trim housing for a linear light source 2 and three stainless steel edge trim frames 3. An inverter 9 is connected to a linear light source 4 inside the trim housing for a linear light source 2.

FIG. 2 shows the configuration of the linear light source 4, i.e., cold cathode fluorescent lamp (hereinafter referred as CCFL), and its trim housing 2. The length of the linear light source 4, CCFL, is adapted to the length of the top edge surface 18 of the light-transmitting panel 1 and is installed inside the trim housing 2 with the longitudinal semi-circular light reflector 5 covering the backside of the linear light source 4, CCFL, to efficiently reflect and direct the light from the linear light source 4, CCFL, toward the top edge surface 18 of the light-transmitting panel 1. The electrical power lines from the inverter 9 are connected to the lead wire at each end of the linear light source 4, CCFL. Once the linear light source 4, CCFL is installed inside the trim housing 2, the assembled trim housing 2 can now be attached to the top edge surface 18 by pushing so that the two holes 16 on the light-transmitting panel 1 line up with the matching holes 17 on the trim housing 2. By inserting the two tubular pins 10 through the holes 17 and 16 on both ends of the trim housing 2, the attachment of the linear light source trim housing 2 to the light-transmitting panel 1 is completed.

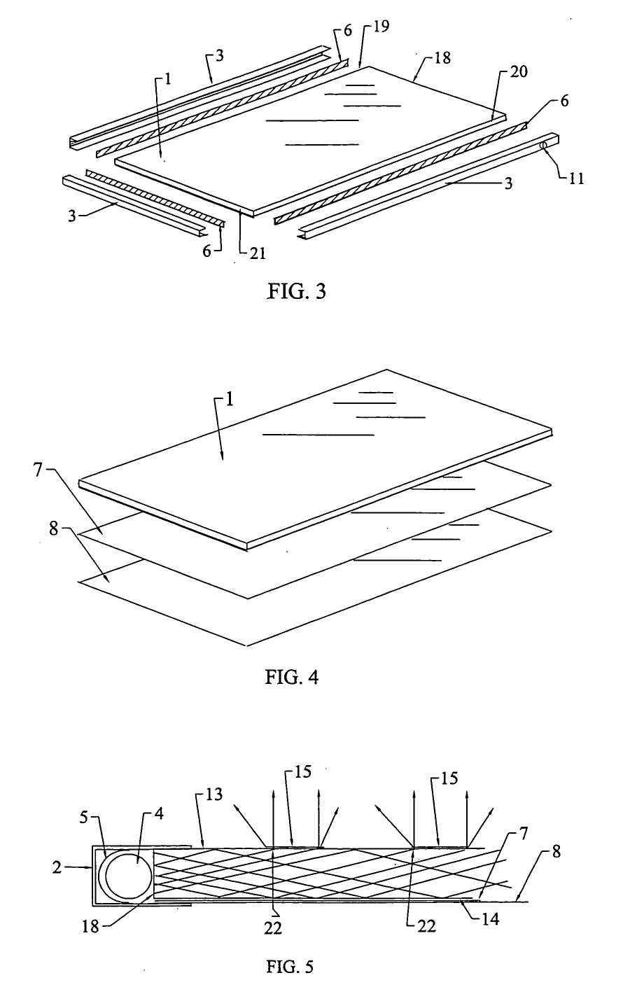

FIG. 3 shows the assembly process of three edge trim frames 3 on the light-transmitting panel 1. Before the three stainless steel edge trim frames 3 are screwed onto the three edge surfaces 19, 20 and 21 of the light-transmitting panel 1, three light reflecting tapes 6 are firmly affixed to three exposed edge surfaces 19, 20 and 21, and a light reflection panel 7 and a protective back panel 8 are attached to the bottom surface 14 of the light-transmitting panel 1 as shown in FIG. 4.

Light introduced into the top edge surface 18 of the light-transmitting panel 1 will be internally reflected and refracted between the top surface 13 and bottom surface 14 of the light-transmitting panel 1. The rays of light 22 entering the top edge surface 18 travel within the light-transmitting panel 1 undergoing repeated reflection and refraction processes. The light reflecting tapes 6 affixed to the three edge surfaces 19, 20, 21 and the light reflection panel 7 attached to the bottom surface 14 of the light-transmitting panel 1 are designed to keep the light emanating from the linear light source 4 within the light-transmitting panel 1 to ensure maximum reflection of the light therein. The repeated reflection and refraction of the rays of light 22 within the light-transmitting panel 1 illuminate the traces of the opaque pigment markers 15, and make such traces appear bright and glowing to the eyes of observers.

We claim:

1. An edge-lit lighted panel for bulletin boards comprising:
a) an optically transparent light-transmitting panel having top and bottom parallel opposing surfaces and a plurality of edge surfaces;
b) a light reflection panel and a protective back panel;
c) a plurality of light reflecting tapes and protective trim frames for said edge surfaces; and
d) at least one linear light source provided along at least one said edge surface of said light-transmitting panel.

2. The edge-lit lighted panel for bulletin boards of claim 1, wherein said linear light source is installed within a protective trim housing with a longitudinal semi-circular light reflector back cover so that light emanating from said linear light source is efficiently reflected and directed to enter adjacent said edge surface of said light-transmitting panel;

3. The edge-lit lighted panel for bulletin boards of claim 1, wherein said light reflecting tapes are affixed to said edge surfaces and said light reflection panel is attached to the bottom surface of said light-transmitting panel to keep the light emanating from said linear light source within said light-transmitting panel to ensure maximum reflection of the light therein; and

4. The edge-lit lighted panel for bulletin boards of claim 1, wherein said light traveling through said light-transmitting panel illuminates the traces of opaque pigment markers on said top surface of said light-transmitting panel, and makes the traces of said opaque pigment markers appear bright and glowing to the eyes of observers.
